(19) United States
(12) Patent Application Publication
(10) Pub. No.: US 2005/0034070 A1
(43) Pub. Date: Feb. 10, 2005

(54) Method, system of devices, and computer program product for the production of a printed document from several input files

(76) Inventors: Manfred Meir, Ottobrunn (DE); Karl M. Tischler, Neuburg/Donau (DE)

Correspondence Address: SCHIFF HARDIN, LLP;PATENT DEPARTMENT, 6600 SEARS TOWER, CHICAGO, IL, 60606-6473, US

(21) Appl. No.: 10/498,207

(22) PCT Filed: Dec. 9, 2002
(86) PCT No.: PCT/EP02/13933

(30) Foreign Application Priority Data
Dec. 10, 2001 (DE) 10160607.9

(51) Int. Cl. G06F 17/21

(52) U.S. Cl. 715/530

(57) ABSTRACT

In a system and method for generating a printed document from a plurality of files that respectively comprise data for a predetermined number of pages, a print pre-processing system is provided. The files are stored as an input in a logical input storage region of the system. With the test program module, it is automatically determined which input files are to be joined into a cluster file. By a combination program module, the cluster file is created from the associated input files and stored in a logical cluster storage region. It is tested whether files belonging to a cluster file are already present, and as necessary the cluster is automatically forwarded to a printer for output as a signature.

### BACKGROUND

The system and method relates to a method, a device system and a computer program product to generate a printed document from a plurality of input files.

In particular, the system and method relates to a method for preparation of print data that are used for printing a newspaper or a periodical. In production systems to create such printed matters, it is typical to print the print data on what are known as signatures. On such signatures, a plurality of pages of a document are printed on a connected recording medium (single page web or paper web) in a specific arrangement such that, when the recording medium is cut and folded in a manner characteristic for the signature, the page sequence of the finished document thereby created precisely corresponds to the predetermined, desired sequence.

A method and a system for printing signatures is known from U.S. Pat. No. 5,398,289. A method and system for processing of print data per signature is also known from WO-A1-00/68877.

In the field of digital printing, a specialty has formed, what is known as “Print on Demand” (PoD). A corresponding PoD system is, for example, specified under the title “Entwicklung neuer Medien-Konzepte für PoD-Dienstleister” in the periodical Deutscher Drucker, Nr. 35/98 from 17 Sep. 1998. The content of the printed matters cited above is hereby included by reference in the present specification.

In contrast to conventional offset printing, an advantage of PoD systems is that print goods can be produced in a relatively short time (just in time) on demand and, in the event that it is desired, prepared with additional data when required. Small runs of approximately 2 to some ten thousand copies of documents can thereby be economically printed. Upon request, a specific, currently necessary number of the respective documents can thereby be printed on short notice. Costs for the storage as well as the surplus printed documents can thereby be saved.

In the field of newspaper printing, it has been typical until now to centrally print newspapers in large runs (some hundred thousand) and then to distribute them regionally and worldwide via transport routes of all types, including by ship and by air. In particular for daily newspapers, the problem exists that they can no longer be delivered up-to-date because the transport route is too long or because they must already be transported across date lines during transport.

From United States Patent Publication No. 2001/0039553 A1, a document management system is known in which associated files are characterized by a marking and are thus clustered.

### SUMMARY

It is an object to enable, with optimal cost and time savings, the on-demand printing and delivery of documents that comprise a plurality of pages.

In a system and method for generating a printed document from a plurality of files that respectively comprise data for a predetermined number of pages, the files are received with a print pre-processing system. The files are stored as an input and are filed in a logical input storage region of the print pre-processing system. With a test program module, it is determined which input files are respectively to be joined into a cluster file comprising a plurality of associated input files. By a combination program module, the cluster file is created from the associated input files and stored in a logical cluster storage region. It is tested whether files belonging to a cluster file are already present, and as necessary the cluster file is forwarded to a printer for output as a signature.

### BRIEF DESCRIPTION OF THE DRAWINGS

FIG. 1 illustrates a location-spanning newspaper production system;

FIG. 2 illustrates a print pre-processing system;

FIG. 3 is a display mask of a print pre-processing computer program module;

FIG. 4 shows the mask of FIG. 3, according to which various cluster files have been generated from individual files;

FIG. 5 illustrates the mask of FIG. 4, according to which the cluster files have been converted into “PDF files”;

FIG. 6 illustrates the screen display of a converted cluster file,

FIG. 7 is a program menu with monitoring windows to generate individually defined cluster files;

FIG. 8 illustrates the display of the computer program module in completely automatic load;

FIG. 9 illustrates a selection window for transmission of converted cluster files to a print production system;

FIG. 10 illustrates the selection possibility of various predefined filters, as well as various programs to generate the cluster files; and

FIG. 11 illustrates a filter setting menu.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

For automatic generation of printed documents from a plurality of files that respectively comprise data of a predetermined number, it is provided for a print pre-processing system to receive the files. The transmission of the data can thus occur over arbitrary lengths and electronic transfer media, in particular via local computer networks (Local Area Network, LAN) or via a secure or insecure Internet connection (Wide Area Network, WAN).

In the print pre-processing system, the received files are stored in a logical input storage range, and it is then determined by a test program module which input data are respectively to be connected with one or more cluster files comprising input files. The test program module can be started automatically or manually. In the case of the automatic start, this can in particular occur automatically at certain time intervals, such that a cluster file comprising a plurality of input files can respectively be formed immediately after input of all input files belonging to the respective cluster, and as needed the corresponding cluster file is created directly and forwarded for per-signature output.

After testing the input files via the test program module, the cluster files are created from the associated input files by means of a combination program module (merger module) and stored in a logical cluster storage region. The cluster files are subsequently selectively directly forwarded to the print device or a print production system connected in-between for per-signature output on a print device. In the print production system, the cluster files can be imposed (meaning re-sorted per page, adapted to signature) and/or the data that are then forwarded to a high-capacity printer for per-job processing are rastered if necessary.

Because the editor can create his respective article page-by-page—and, if necessary, spanning pages—a very high flexibility results via the procedure, in which from individual pages that are in particular created in an editing system of a newspaper editor, and in which the individual page files are sent to a print pre-processing system. Furthermore, the page files can immediately be completely or partially automatically sent to the print pre-processing system after completion of the corresponding pages. After input of all page files belonging to a cluster into the print pre-processing system, the corresponding newspaper signature can immediately be created from the associated cluster file, and a virtually edit-fresh print can thus occur.

This edit-fresh print can advantageously occur not only at the editing location, but rather at any arbitrary location at which a technical data connection exists. The corresponding newspaper copies thus no longer have to be transported as print copies over large distances, but rather are only still distributed as data over the corresponding data networks, in particular worldwide. Thus, for example, a newspaper published in Germany can be created and distributed practically at the same point in time in Australia as in the country of origin (Germany).

Via the largely automated procedure of the preferred embodiment, it is in particular possible that large data quantities (for example up some hundred pages) are completely automatically merged into clusters and checked regarding their consistency.

In a preferred exemplary embodiment, a print file is created from the cluster file, the print file being in particular suitable for a fast printing in a high-speed print system, for example in what is known as the Advanced Function Presentation Datastream (AFPDS), in the Intelligent Printer Datastream (IPDS), in PostScript (PS), in Printer Control Language (PCL), or in the data stream LCDS, which was developed by the company Xerox Corp. The print file so generated then in particular comprises a plurality of print signatures, and this print file is then in particular supplied to an imposition program in which the precise print sequence is determined, so that the successively printed signatures at the end of the printout precisely correspond to the desired page sequence within the document.

The automation of the event can in particular be expanded, in that in the testing event an automatic filter function is provided with which the input files are searched through and the buffer files are created according to predetermined criteria. It is in particular advantageous when information about the entire document is already contained in the input data, for example about the total page count, about the scale of the pages of a cluster, and/or about a signature. This overall information data can alternatively be transmitted in a separate corollary file and/or can be transmitted within the single-page files, in particular in the form of a standardized file name of the single-page files.

A further automation of the process can in particular occur in that the storage range for the input files can be automatically checked in regular intervals upon the input of new files, for example within a few seconds, and that it is checked whether all files belonging to a cluster are already present, such that the creation of the associated cluster file can be started completely or partially automatically.

To monitor the input and/or cluster files, it is in particular advantageous to enable the display of the respective file content via a corresponding display program. In principle, all file types that are suitable for document reproduction (however in particular file formats that require relatively little storage space such as, for example, the format PDF) are suitable as data formats for the input files and/or the cluster files. However, it is also conceivable to employ the system with more storage-consuming file formats such as, for example, “TIF” or “Bitmap” (BMP) data comprising rastered image data.

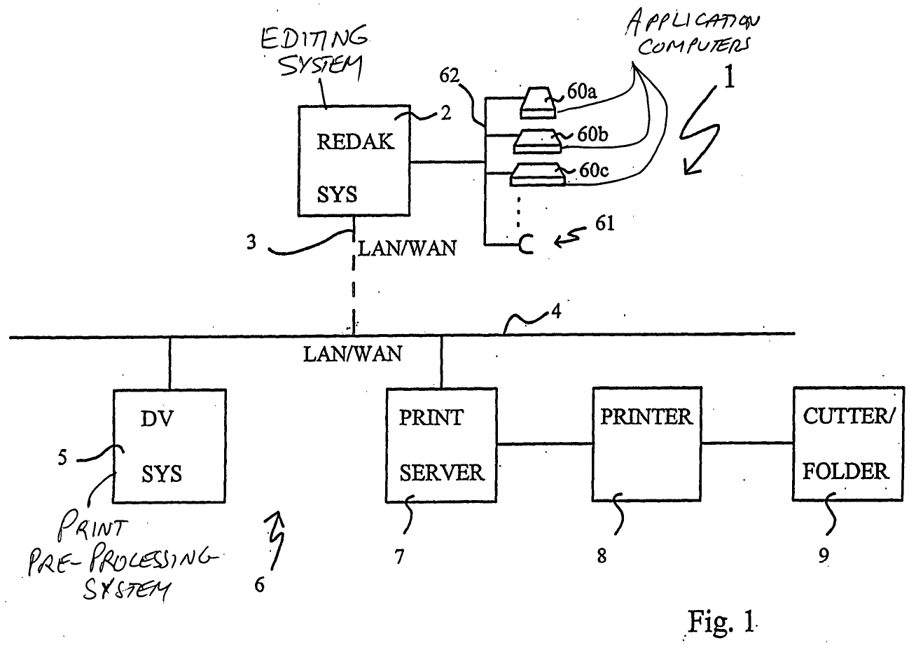

A production system 1 for newspapers, periodicals or comparable documents is shown in FIG. 1, in which a plurality of devices are networked with one another. Newspaper editors create their articles on application computers 60a, 60b, 60c, etc. that attach to a secure data network 3 (LAN, WAN). Further articles can be imported from arbitrary locations or data sources via an interface 61. An editing system 2, in which the finished newspaper articles (composed page by page) are output to individual files, attaches to the data network 3 with which these data can be transmitted to other computers either locally to a common location (Local Area Network, LAN) or location-spanning, in particular worldwide via a suitable network (Wide Area Network, WAN) such as the Internet. The various articles are merged into pages of the newspaper in a composition module. The single-page files generated in the editing system 2 are then transferred via the network 3 to a print pre-processing system 5. This can occur either directly at the print pre-processing system 5 or—as shown in FIG. 1—via a second network 4 which is provided at the print production location or at the print production system 6. The second network 4 can thereby likewise be a local network (LAN), or in turn can be a location-spanning network (WAN), for example the Internet. The three networks 3, 4 and 62 can also be connected among one another.

The single-page files created by the editing system 2 are combined in the print pre-processing system 5 into cluster files that respectively comprise a plurality of single pages. The cluster data are then converted into signature data (imposition event), the signature data is printed, and the print goods thereby generated are folded and/or cut such that a predetermined page sequence (for example the page sequence “1, 2, 3 etc.”) is generated in the finished document. A corresponding print production system is shown in WO-A1-00/68877, in particular in FIGS. 1, 2 and 19, whose content is again explicitly included in the present specification. The clusters respectively contain, for example, a whole-number multiple of 4 (four) pages, in order to be printed out in an electronic print system that respectively produces signatures with corresponding whole-number multiples of four.

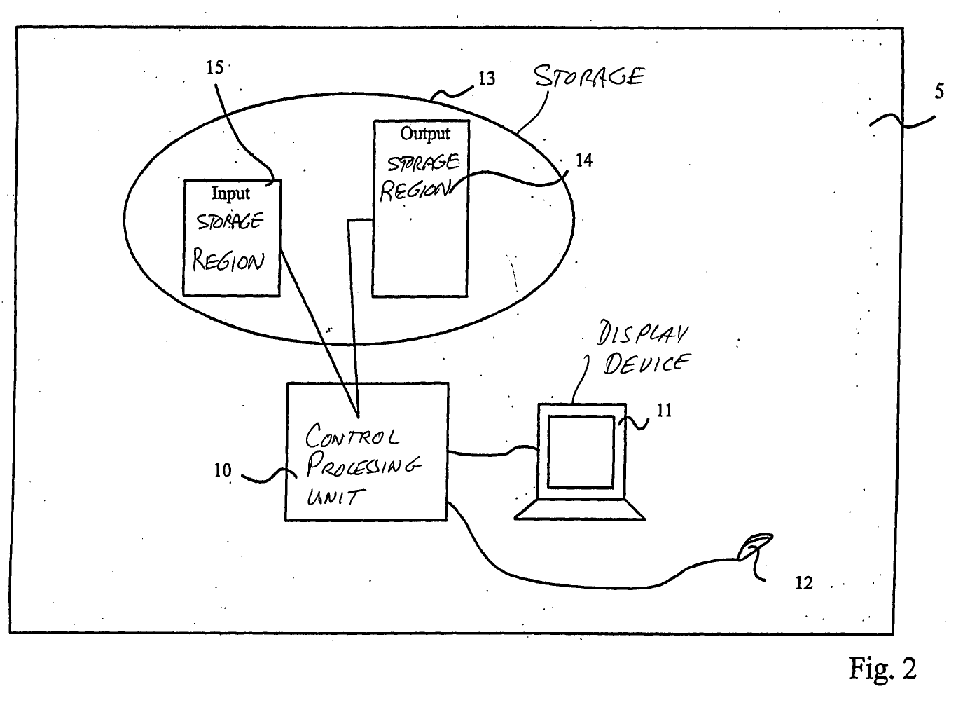

Print server 7, printer 8 and post-processing devices 9 (cutting device, folding device) are shown only schematically in FIG. 1. The computer program module specified in WO-A1-00/68877 in FIGS. 2 through 13 to generate signatures can alternatively run in the print pre-processing system 5 or also in the print server 7 in the present system.

Shown in FIG. 2 are the significant system components of the print pre-processing system 5 with which a cluster file is generated from the single-page files that are received from the editing system 2.

For this, the print pre-processing system 5 can be designed as a computer (personal computer) that comprises a central processing unit 10, a display device (monitor) 11, and an input unit (mouse) 12. In a storage 13 the incoming single-page files are stored in an input storage region 15, and the outgoing cluster files are stored in an output storage region 14.

Within the print pre-processing system, a computer program module runs that controls the entire procedure cycle. The individual page files are transmitted from the editing system 2 to the print pre-processing system 5 as one-page PDF files. In the print pre-processing system 5, these files are then checked for the following criteria:
which files belong to the current newspaper to be processed
how high is the number of pages per newspaper
how large is the number of the cluster (i.e. the newspaper signatures)
how large is the page range within a cluster
are all files of a cluster present, meaning is the cluster complete.

When all tests have been affected and the corresponding parameters of a newspaper, for example the page range of a specific cluster, are determined, the testing event is ended and the next processing step of the merging of files using the composition program module (merge program) can follow.

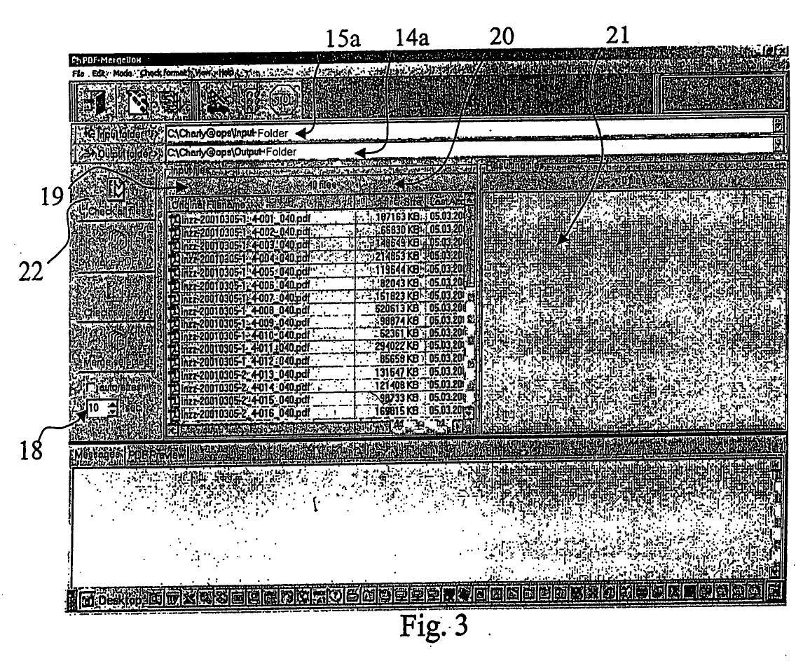

Shown in FIG. 3, appearing on the monitor 11, is the image display that appears when the computer program module to merge the individual page files into cluster files is called. The input storage region is shown in a display line 15a and the output file is shown in a display line 14a. Shown in the input window 20 are all files that exist in the input storage region 15. In the files shown in FIG. 3, the following naming convention is thereby observed:
nnnn-yyyymmdd-x_S-ZZZ_PPP.PDF

whereby:

nnnn=abbreviation of the newspaper name (for example, International New Zurich Times=Inzz)

yyyy=year (here 2001)

mmdd=month and day (here 5th March), possibly: 0305

x=number of the current cluster

S=total number of clusters

ZZZ=current page number

PPP=total page number (here 40).

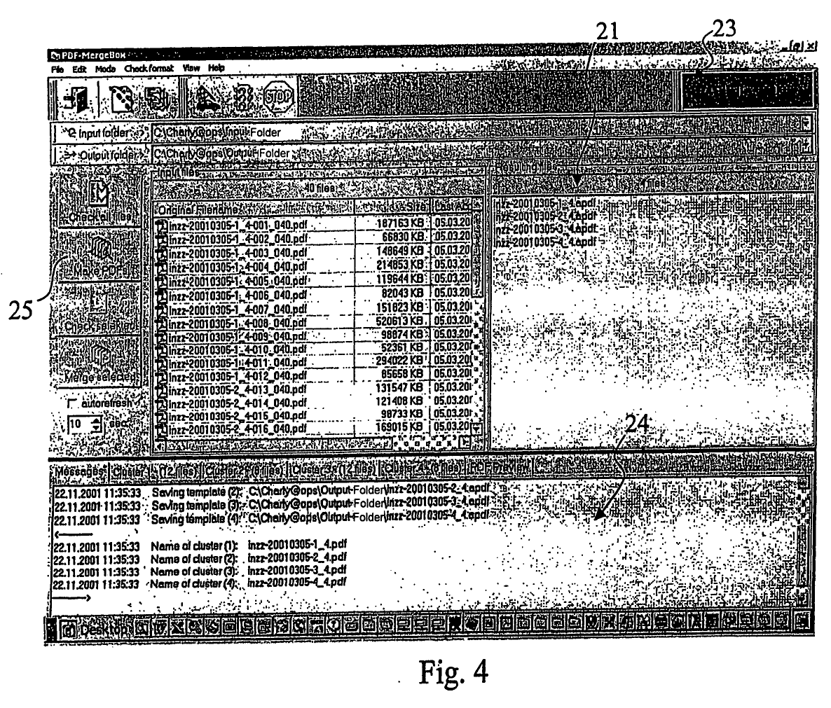

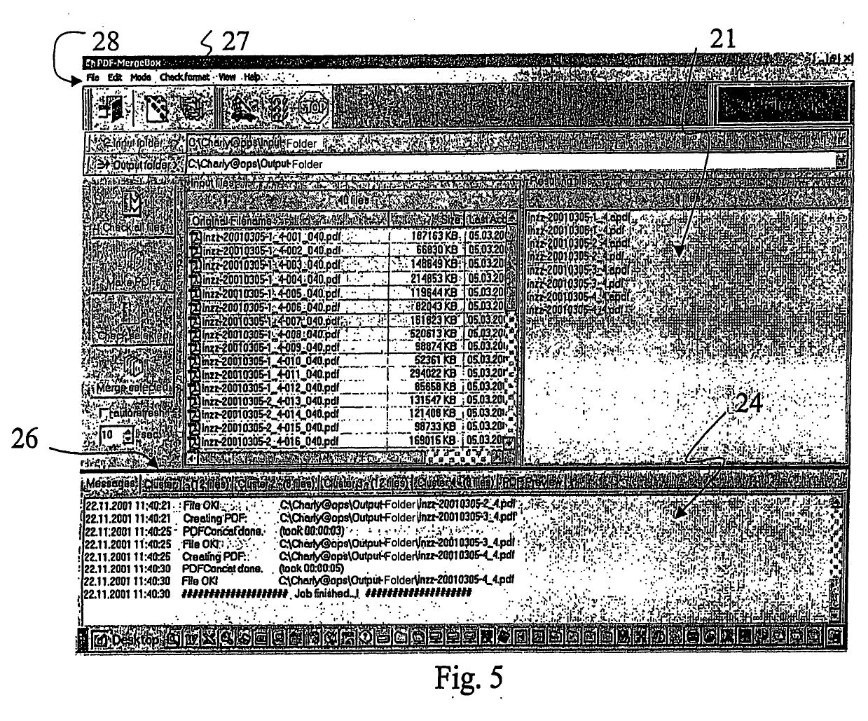

The files of the input region are tested with the test button regarding the criteria cited above, in particular regarding the completeness of a cluster. After operation of the button 22, the button shown in FIG. 4 appears when all files belonging to the newspaper are complete. In the status window 23, it is indicated that all 40 files are in order. In the output window 21, four “APDF” control files are shown that have been generated by the testing event in the output storage region 14. They comprise control information to form the cluster, such as, for example, specifications about all single-page files belonging to the cluster (here, for example, their file name) and/or about the desired storage location of the cluster files. The testing event and the implemented operation are protocolled in the notification window 24. In order to generate the “PDF” cluster files, henceforth the button 25 is operated. This leads to the display that is shown in FIG. 5. For this, system notifications are output again in the notification window 24. As an alternative to this, with the sliders 26 it can be individually considered which files of the input region 15 have been merged into the respective cluster. On the sliders, it is respectively specified how many files are merged in the corresponding cluster.

The linking of the individual files into a single PDF file occurs via a corresponding composition program module (merge program module) that operates in command-line mode and is called by the main program module (PDF merge box) via specific parameters. For this, two different composition program modules, “PDFConcat” and “AppendPDF” can be selected between. Both of these programs differ with regard to some secondary functions such as, for example, the possibility to maintain integrated bookmarks in a PDF file, to display the work progress, or to attach a protocol file (log file) via implemented operations.

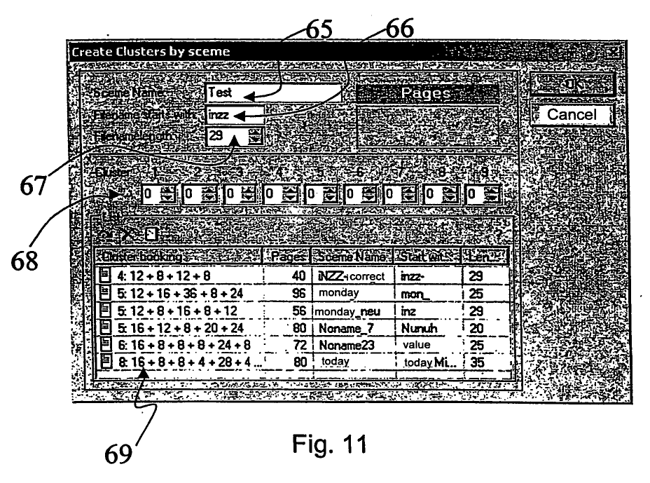

The selection occurs via the menu point 27 “Check format” given in the menu bar. The associated selection menu 70 is separately shown again in FIG. 10. Some predefined filter formats for various newspapers are selectable therein, for example the filter format “inzz” for the “International New Zurich Times” or the filter format “BOR” for the newspaper “Borsen Denmark”. As an alternative to this, a selection from a group of filters can be made via the menu point “By Cluster Scheme”. The menu shown in FIG. 11 can be called via the menu point “Make Cluster Scheme”, whereby further filters can be defined.

The number of the current files stored in the input storage region 15 is displayed in the uppermost line 19 in the input window 20. These 40 files are shown in the example of FIG. 3 with one page per. As is recognizable using the file nomenclature of the input files, the total newspaper is comprised of exactly 40 pages (compare the last number of the file name before the ending “PDF”). In the indicated cast, all files have already arrived. In order to automatically update the file lists upon arrival of the new files, a hook can be set in the input window 18 (autorefresh), and the time intervals are set in second-precise manner between the individual updating events.

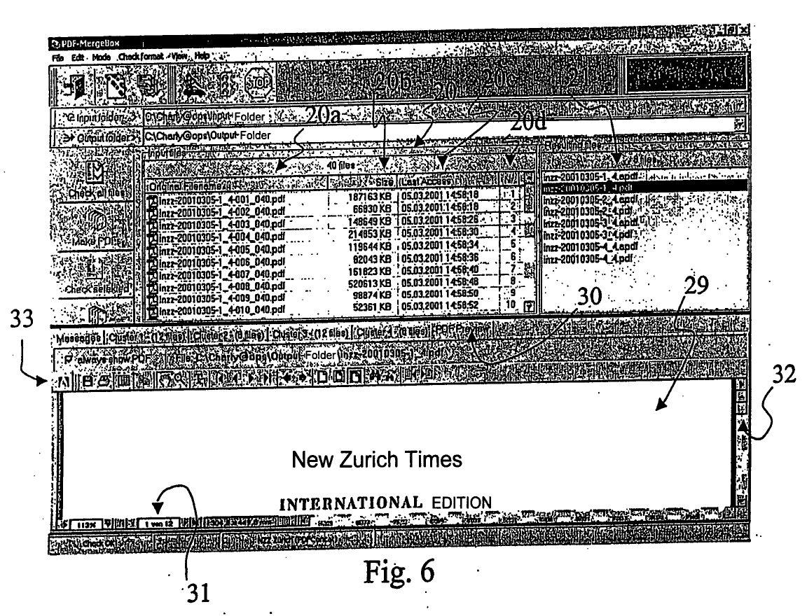

In FIG. 6, the input window 20 and the output window 21 are shown again. The input window 20 is divided into four columns: column 20a designates names of the respective input files; their size is indicated in kilobytes in column 20b; date and time of the last access is indicated in column 20c; and a running number regarding the input storage region 15 is given in column 20d.

Furthermore, it is recognizable in the output window that the cluster file “inzz-20010305-1_{—}4.pdf” is selected, meaning backed in black. The content is indicated in the display window 29, which has been enabled via selection of the slider 30 “PDF Preview”. The selection of this slider 30 starts a corresponding display program (here for example the program Acrobat Reader® by the company Adobe) whose display is superimposed on the notification window 24. In the page display region 31, it is to be read off that the first page is selected of the 12 pages that comprise the file “inzz-20010305-1_{—}4.pdf”. The data content within this page or within the 12 pages can be scrolled through with this slider 32. For the rest, the known functions of the Acrobat Reader display program can be used via the Acrobat menu bar 32, such as storage, printing, divided display, enlargement, searching a text, etc.

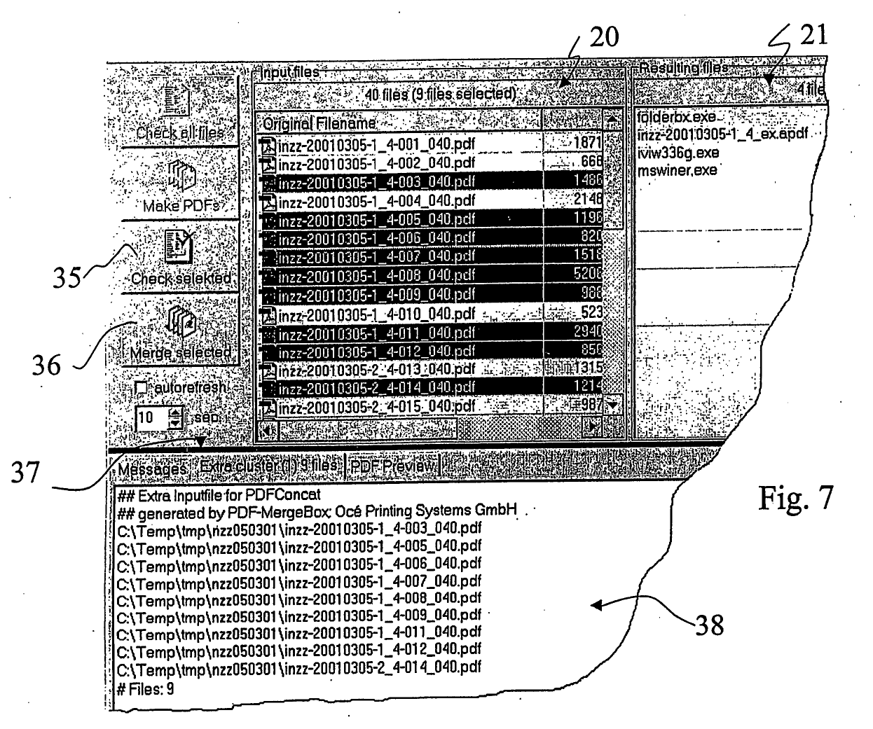

A program process supported by the computer program is shown in FIG. 7 via the associated display window. In this display mode, individual files can be selected in the input window 20 in arbitrary combinations to form a freely determinable number of cluster files. The selected files are in this case highlighted with black. Nine files are selected in the shown example. These files can be tested with the test button 35 in terms of their consistency with regard to naming convention and/or other conventions. Using a display window (not shown), it can be determined how many cluster files should be generated. In the shown example of FIG. 7, only one cluster file is determined which is visible using the single cluster slider 37. All 9 files selected for the extra cluster are shown again in the cluster display window 38.

The formation of a single, individually compiled cluster file is, for example, advantageous when one cluster file should precede the print events of the remaining cluster files, or when an already deleted cluster file should be reproduced again.

In order to determine, if necessary, in which of the individually generated clusters a group of selected files is to be included, the selected files are to be moved with what is known as the Drag & Drop technique from the input window 20 into the corresponding cluster display window 38, meaning dragged into the corresponding cluster display window or the corresponding cluster list given a pressed left mouse button. The file names or the corresponding files, including their paths, are thereby inserted into this list at the correct location, namely sorted alphabetically and numerically. In order to remove file entries again, the corresponding files are marked and detected from the cluster list via a delete operation. The file deleted in the cluster list then appears again in the list of the input files in the display window 20. By operating the combination button 36, these new single-page files are combined into a single cluster file, and the file thereby generated is shown in the display window 21. Moreover, a corresponding control file with the ending “APDF” is generated in the output storage region and shown in the output window 21.

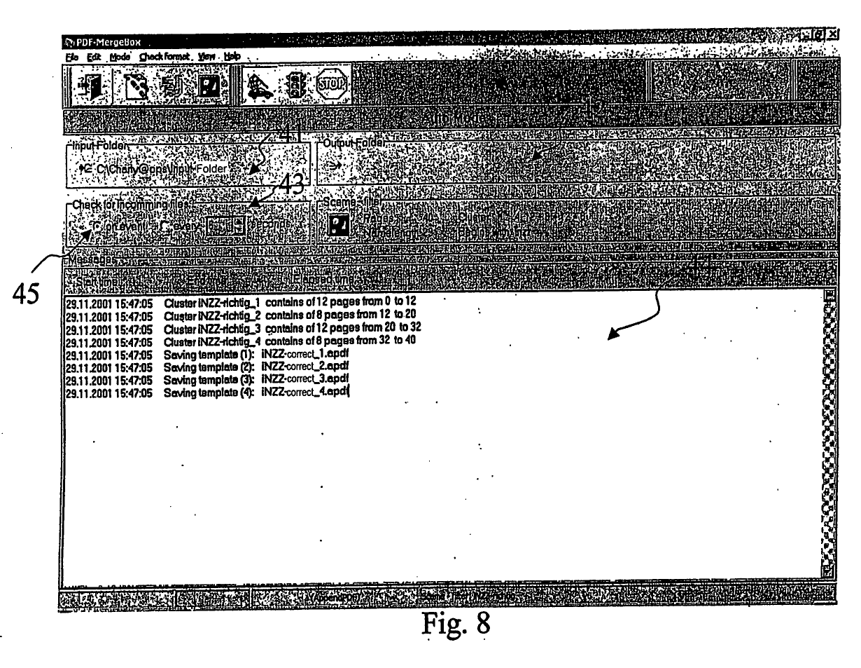

A completely automated processing process is henceforth illustrated using FIG. 8. This completely automated operating mode is provided for an unsupervised monitoring of incoming files. The incoming files must thereby correspond precisely to a predetermined criterion such as, for example, a specific name format, or even control information provided by means of the file or with an auxiliary file. Via corresponding search mechanisms, in particular filters that correspond to the file names, the process can be fully automated. It is thereby recognizable in FIG. 8 that—like in the partially automated operating mode specified above—an input file must be determined in the menu bar 41 and an output file must be determined in the menu bar 42. Furthermore, a time interval in which the input order is respectively checked for new files can alternatively be input in seconds, or it can be stated via the menu point 45 that the automatic actions for file checking and cluster formation respectively occur upon arrival of new files in the input index.

When all files of a predetermined job (for example, for production of a complete newspaper) are transmitted, checked and completely merged into all corresponding cluster files, an instruction window “end process” appears, and/or the cluster files are automatically sent to a print production system for per-signature printing. The automatic monitoring process is likewise automatically deactivated as soon as all automatic operations are fulfilled. The respectively implemented working process steps are shown in the display window 42 in the form of system messages.

A predefined filter that is used in the fully automatic operating mode can be selected in menu field 46 (see also FIG. 11). In the example of FIG. 8, all files are examined whose name begins with “inzz-” and is in total 29 characters long. The entire document has 40 pages and is divided into four clusters whose page range is twelve, eight, twelve and eight pages (compare the filter “inzz-correct” of FIG. 11).

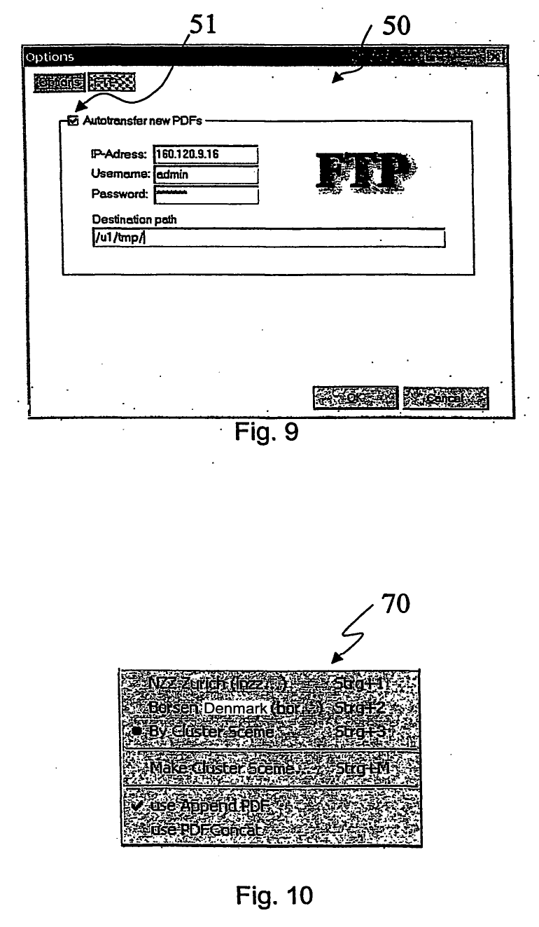

In FIG. 9, a display window 50 is shown with which a complete set of cluster files can be sent as a print job to a print production system, for example to a print processing program of the print server 7 (compare FIG. 1). The print job can thereby be completely produced into a newspaper or into a brochure on a printer in arbitrary edition. Only the IP address of the print server, an allowed user name and its password, and a specific target path within the print server 7 are to be input. This input can occur in corresponding input fields that are shown in display window 50. Via an option “Autotransfer” 51, it is also possible to transfer complete file systems directly to the print server, such that this product step is also fully automated. The file transfer can occur with a known data protocol such as, for example, FTP (file transfer protocol), TCP/IP (Transmission Control Protocol/Internet Protocol), or also another suitable protocol.

In FIG. 11, a selection menu is shown with which the filter settings can be determined to check input files and to form cluster files. In the input field 65, a name is thereby input for the respective filter, and it is specified in the input field 66 with which designation the respective input field of a specific newspaper begins (for example, Inzz for International New Zurich Times). The total length of the input file designations is given in the input field 67: in the example of the International New Zurich Times (compare FIGS. 3-5), these are 29 characters. The total page counts of the respective cluster are to be input in the setting window 68 for up to nine clusters. Corresponding specifications for already predefined filter schemes are to be learned in the window 69. For example, the filter with the name “Inzz-correct” is divided into clusters, of which the first cluster comprises 12 pages, the second cluster comprises 8 pages, the third cluster comprises 12 pages, and the fourth cluster again comprises 8 pages. From this, it can be recognized that the page count of the cluster is respectively a whole-number multiple of four.

A system has been specified with which production processes can be largely automated to produce brochures and newspapers, such that these can be output on a print system per cluster or per signature with high speed. The system is in particular suited to decentrally implement various process steps of the overall process over large distances, in particular over a worldwide network, such that at the end of the production chain the printing can be implemented with the highest speed at an arbitrary location of the work. It is thereby possible to print out up-to-date newspapers worldwide, meaning only a short time (a few seconds to hours) after the completion given an editing at arbitrary locations.

Via the disclosed system and method, production steps can be split up given creation of a document at various production locations, and it is in particular possible to execute the production steps at individual locations in a network of computers. The system and method can thus be realized both in corresponding computer program modules, in computer program products such as, for example, CD-ROMs, in the form of files, or even on device systems. They can in particular be realized as computer software that can run on known computer systems.

The system and method can be arbitrarily further developed and realized in various embodiments. For example, it plays no role on which operating system the individual program sections run. In particular, it is possible to network various computers with various operating systems such that the production cycle is enabled according to the present system. Furthermore, instead of single pages, a predetermined number of pages per page file can also respectively be transmitted from the editing system to the print pre-processing system.

In summary, it can again be asserted that it is enabled with the present system to combine brochure pages that are delivered divided as individual pages over specific time periods into groups. For this, the input files are examined and checked with regard to specific criteria. In order to enable the production of the newspaper within a narrow time window, via the system an at least partially-automatic working method is proposed with which the checking is largely automated. In order to also enable this for files that have new or different or even no conventions whatsoever with regard to their name and/or information about the range of clusters or, respectively, signatures, a manual combination of input data into individually designed clusters is also possible.

Via the use of naming conventions, it is possible to specify filter systems using which of the necessary tests of the files can occur automatically. An advanced automation of the working process can be achieved when an automatic merging of the clusters (file groups) occurs. Given compliance with the naming conventions, an automatic, unattended testing of the input files and combination of the cluster files can thereby occur. Furthermore, an automatic transfer of the result files (cluster files) can be provided at a print production system, such that signature data are formed from the cluster files. The signature data are adapted to the print system or to the print post-processing system (such as, for example, to folding and cutting devices) such that the finished produced document exhibits a predetermined page sequence.

Via the system and method, a significant time savings is achieved given decentralized printing of newspapers, as well as a more secure workflow in the creation of newspapers at decentralized locations. Two operating modes are thereby provided, namely what is known as an interactive mode, in which the following processing steps are partially-automatically supported:

testing and linking of page files using a set filter

creation of individual clusters and association of the files via Drag&Drop

linking of selected page files into an individually combined cluster

preview of the page files and the cluster files

output of notification at any processing step

display of general file information for improved monitoring of the files

automatic new reading of the adjusted indices

In a fully-automatic operating mode, the adjusted indices are automatically read upon the input of new files, the input files are tested using the adjusted filter, and the cluster files are automatically generated when all input files belonging to this cluster are present and, if necessary, the cluster files are forwarded to a print production system for generation and printing of the associated signatures.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-22. (cancelled)

23. A method for generating a printed document from a plurality of files that respectively comprise data for a predetermined number of pages, comprising the steps of:
inputting the files to a print pre-processing system;
storing the files in a logical input storage region of the print pre-processing system;
with a test program module, automatically determining which input files are respectively to be joined into a cluster file comprising a plurality of associated input files;
by a combination program module, automatically creating the cluster file from the associated input files and storing the cluster file in a logical cluster storage region of the print pre-processing system; and
automatically testing whether all files belonging to a cluster file are already present, and as necessary automatically forwarding the cluster file to a printer for output as a signature.

24. A method according to claim 23 wherein a plurality of input files are transferred.

25. A method according to claim 24 wherein each input file corresponds to precisely one print page.

26. A method according to claim 23 wherein one print signature is generated from each cluster file.

27. A method according to claim 26 wherein the signature is generated in a print production system.

28. A method according to claim 23 wherein a print file is created from the cluster file in a predetermined language.

29. A method according to claim 28 wherein the print file comprises a plurality of print signatures.

30. A method according to claim 23 wherein a filter is automatically applied via which the cluster file is created according to predetermined conventions.

31. A method according to claim 23 wherein it is determined with a determination module which input files are to be connected to a signature, and the testing step then occurs via the test program module.

32. A method according to claim 23 wherein the input files are checked for at least one of the following criteria:
which file belongs to a newspaper corresponding to a currently activated filter,
how large is a number of pages of the newspaper,
how large is a number of the clusters,
how large is a page range within a cluster, and
are all files of a cluster present.

33. A method according to claim 23 whereby input files are associated with a cluster in a manual operating mode via drag and drop.

34. A method according to claim 23 wherein in a fully automatic operating mode it is automatically and regularly tested using a filter whether all input files for all clusters of a brochure are present in the input data storage region; the input files are automatically tested with the filter regarding their consistency; and the cluster files are then automatically formed without user intervention.

35. A method according to claim 34 wherein the cluster files are automatically transmitted to a print production system in which signature print data are formed from the cluster files.

36. A method according to claim 23 wherein at least one of the input files and the cluster files are observed by means of an observation program that is called directly by the cluster generation program.

37. A method according to claim 23 wherein print files are first created.

38. A method according to claim 23 wherein information about the entire document is contained in the input files.

39. A method according to claim 38 wherein the information is contained in a file name.

40. A method according to claim 23 wherein information about the entire document is contained in a corollary file.

41. A method according to claim 38 wherein the information comprises at least one of information about a total page count, about a range of the pages of a cluster, and about a signature.

42. A system for generating a printed document from a plurality of files that respectively comprise data for a predetermined number of pages, comprising:
a print pre-processing system having a control processing unit and a storage, said storage comprising a logical input storage region and a logical cluster storage region;
a printer;
said logical input storage region having files stored therein as an input;
a test program module for the control processing unit which automatically determines which input files are respectively to be joined into a cluster file comprising a plurality of associated input files;
said control processing unit also having a combination program module which automatically creates the cluster file from the associated input files and stores the cluster file in said logical cluster storage region; and
with the control processing unit, automatically testing whether all files belonging to a cluster file are already present, and as necessary automatically forwarding the cluster file to said printer for output as a signature.

43. A system according to claim 42, comprising at least one computer as said control processing unit with a network connection and said printer being connected with the computer.

44. A computer program product for use with a computer and a printer, said computer having a logical input storage region and a logical cluster storage region, comprising:
said program product storing files in the logical input storage region;
said program product including a test program module which automatically determines which input files are respectively to be joined into a cluster file comprising a plurality of associated input files;
said program product including a combination program module automatically creating the cluster file from the associated input file and storing the cluster file in said logical cluster storage region; and
said program product automatically testing whether all files belonging to a cluster file are already present, and as necessary automatically forwarding the cluster file to said printer for output as a signature.

45. A method for generating a printed document from a plurality of files that respectively comprise data for a predetermined number of pages, comprising the steps of:
providing a control processing unit and a printer, said control processing unit being connected with a storage with a logical input storage region and a logical cluster storage region;
storing the files as an input in the logical input storage region;
with a test program module, automatically determining which input files are respectively to be joined in a cluster file;
by a combination program module, creating the cluster file from the associated input files and storing the cluster file in the logical cluster storage region; and
testing whether files belonging to a cluster file are already present, and is necessary forwarding the cluster file to the printer for output as a signature.
